(19) United States
(12) Patent Application Publication
(10) Pub. No.: US 2007/0095582 A1
(43) Pub. Date: May 3, 2007

(54) WHEELCHAIR WITH MECHANICAL ARM

(75) Inventors: Henricus Johannes Adrianus Stuijt, Lobith (NL); Gerardus Richardus Bernardus Engelina Romer, 's-Heerenberg (NL)

Correspondence Address: BANNER & WITCOFF, LTD., 28 STATE STREET, 28th FLOOR, BOSTON, MA, 02109-9601, US

(73) Assignee: Exact Dynamics B.V., Zevenaar (NL)

(21) Appl. No.: 11/563,363

(22) Filed: Nov. 27, 2006

Related U.S. Application Data
(63) Continuation of application No. PCT/NL05/00391, filed on May 27, 2005.

(30) Foreign Application Priority Data
May 27, 2004 (NL) 1026282

(51) Int. Cl. B60K 1/00

(52) U.S. Cl. 180/65.1

(57) ABSTRACT

The invention relates to a wheelchair, provided with a seat at a first level and a backrest, supported by an undercarriage, and at least one armrest, located at a second level, above said first level, wherein a mechanical arm is provided, comprising a series of segments, driven by at least one motor, wherein the mechanical arm is foldable and/or retractable into a position wherein the mechanical arm extends virtually completely below said armrest, preferably completely below said second level or virtually completely behind or next to the backrest, at least such that, in folded and/or retracted position, the mechanical arm is virtually completely inside an outer contour of the wheelchair.

### RELATED APPLICATIONS

This application is a continuation of PCT application no. PCT/NL2005/000391, designating the United States and filed May 27, 2005; which claims the benefit of the filing date of Dutch application no. NL 1026282, filed May 27, 2004; both of which are hereby incorporated herein by reference in their entirety.

### FIELD

The invention relates to a chair. The invention particularly relates to a wheelchair with one or more mechanical arms. Such a wheelchair is known from practice.

### BACKGROUND

People with limited mobility often need to rely on the use of a wheelchair. This can be driven manually or electrically. If, in addition, the user has no or a limited arm and/or hand function, the wheelchair can be provided with a mechanical arm with which certain functions such as gripping functions can be taken over. Such a mechanical arm is known by the name of MANUS or ARM and is offered by Exact Dynamics, The Netherlands.

MANUS or ARM is an electrically driven, articulated arm built up from a series of segments, pivotally connected with one another. A basic segment is formed by a tube with a longitudinal axis extending approximately vertically, in which tube drive motors are provided for the different segments. Via toothed belts and/or drive shafts, these motors are connected with the different connecting points between the segments, for adjustment thereof. The tube is connected with the wheelchair such that it can rotate about the longitudinal axis.

In the known wheelchair, MANUS or ARM is attached to the front side of the chair, in front of the front edge of one of the armrests thereof. This causes the mechanical arm to take up relatively much space, which is, for instance, disadvantageous when passing through doorways, pulling up the wheelchair to a table (for instance dining table) and maneuvering with the wheelchair in small spaces and it is very vulnerable, both in an unfolded operative position and in a retracted storage position.

This known mechanical arm further has the disadvantage that, in use, the arm passes and/or needs to pass singular points, so that control is hampered, in particular as a result of the forces occurring near those singular points and the speeds to be realized there.

A further disadvantage of this known mechanical arm is that particularly the transition between a first and second segment, counted from the basic segment, operatively moves within the user's field of vision and the view of, for instance, a worktop on the wheelchair and/or for instance a table and/or the view of the surroundings and/or conversation partner is hindered.

A still further disadvantage of this known mechanical arm is that the range thereof is relatively limited due to the fact that always a compromise is chosen between the available length of the arm, in particular between the basic segment and a gripper, on the one hand and the available space for the mechanical arm on the wheelchair, requiring a compact arm, on the other hand.

### SUMMARY

The invention contemplates providing a chair, in particular a wheelchair, provided with an articulated mechanical arm, in which at least a number of the above-mentioned disadvantages of the known combination are obviated, while maintaining the advantages thereof.

The invention particularly contemplates providing a wheelchair in which the mechanical arm is included in a retracted or storage position such that it does not adversely affect the outside dimensions of the wheelchair.

The invention further contemplates providing a wheelchair of the type described in the opening paragraph in which, in operative position, the mechanical arm has a relatively large range and a great freedom of movement, while it can be stored relatively compactly.

A further object of the invention is to provide such a wheelchair in which the position of the mechanical arm, at least the attachment thereof is adjustable with respect to the user and/or is adjustable with the seat height.

A still further object of the present invention is to provide a wheelchair with a mechanical arm which can avoid singular points and offers a great freedom for control of the gripper.

At least a number of these and further objects are achieved according to the invention with a chair, particularly a wheelchair according to claim 1.

With a chair according to the invention, the mechanical arm can be stored virtually wholly inside the outer contour of the wheelchair. In this context, the outer contour is substantially determined by two contact surfaces on both sides along the outermost parts of the wheelchair, namely a contact surface along the back side of a backmost extending part of the wheelchair and a contact surface on the front side of a foremost part of the wheelchair, viewed in top plan view, while the contact surfaces extend vertically. Due to this compact and suitable storage position, the advantage is achieved that, particularly during riding with the wheelchair, the mechanical arm is well protected from collisions with the surroundings and, in addition, the maneuverability and the freedom of movement of the wheelchair are increased. A further advantage is that the mechanical arm is less visible so that it will be less stigmatizing.

With a wheelchair according to the invention, the mechanical arm is preferably designed such that it has at least seven degrees of freedom, at least offers this to a gripper of the mechanical arm, in addition to the open/close function of the gripper and an optional lift.

In this manner, it is advantageously achieved that singular points can be avoided in the control of the arm, that a greater freedom of movement is obtained, and that the different parts of the arm can simply be kept out of the user's primary field of vision during use. Thus, view is always maintained of, for instance, the gripper, an object present therein, a worktop on the wheelchair and/or a worktop or table at which the wheelchair is present or another object or a person with which the user of the wheelchair desires interaction or, conversely, desires to avoid this.

In a further advantageous embodiment, a wheelchair according to the invention is characterized in that the mechanical arm is displaceable with respect to the wheelchair, in particular along a side of the wheelchair. To this end, a displacement device is provided with which the whole mechanical arm can be displaced, in a storage position and/or in an operative position. An important advantage of such a wheelchair is that the position of the mechanical arm can in each case be adjusted, for instance to a desired function for the user, to a situation of use of the wheelchair and to a desired storage position and/or operative position of the mechanical arm.

Here, it is particularly advantageous if a control of the mechanical arm is provided, in particular at least partly software-mediated, so that the displacement device and the segments of the mechanical arm can be controlled jointly and in mutual connection with one another. In this manner, with the displacement device, singular points can be avoided, the range and the freedom of movement of the mechanical arm can be improved considerably, even with a relatively short arm, and in each case the most suitable position for the mechanical arm can be chosen.

The invention further relates to a mechanical arm, in particular suitable for use within a wheelchair according to the invention.

Moreover, the invention relates to a control unit for a mechanical arm according to the invention.

In addition, the invention relates to a wheelchair where, during use, a shoulder of the mechanical arm, i.e. the transition between a basic segment and the first segment of the arm, extends near a shoulder of the user. In this manner, the mechanical arm is positioned in a suitable manner to cause minimum hindrance particularly during displacement of the wheelchair and, in addition, the mechanical arm will operatively roughly extend like a normal arm of the user if he or she would be capable of using his or her arm, which may be particularly advantageous to the user at least physically, motorically, cognitively and/or psychologically, particularly also in training situations.

### BRIEF DESCRIPTION OF THE DRAWINGS

In the subclaims, further advantageous embodiments of the invention are described. By way of explanation of the invention, advantageous embodiments thereof will be explained in more detail with reference to the drawing, in which:

FIG. 1 shows a wheelchair according to the invention, with a mechanical arm in stored position;

FIG. 2 shows a wheelchair according to FIG. 1, in top plan view;

FIG. 3 shows a wheelchair according to FIGS. 1 and 2, in top plan view;

FIG. 4 shows a mechanical arm according to the invention, in front view and side elevational view, in unfolded condition;

FIG. 4B shows an alternative embodiment of a mechanical arm according to the invention in folded condition;

FIG. 5 shows a mechanical arm according to FIG. 4, in front view, side elevational view and top plan view, in folded condition;

FIGS. 6A-C show the views of a wheelchair according to FIGS. 1-3, with the mechanical arm in unfolded condition;

FIGS. 7A-D show four positions of a mechanical arm according to the invention on a wheelchair in a first alternative embodiment;

FIGS. 8A-D show a wheelchair with mechanical arm similar to the one according to FIGS. 1-6, with a supporting frame, in four different positions;

FIGS. 9A-H show a wheelchair with a mechanical arm in an alternative position, in eight conditions;

FIG. 10 shows a wheelchair with mechanical arm on a displacement device, in different positions;

FIG. 11 shows a wheelchair similar to the one according to FIG. 10, provided with a rail for a displacement device in an alternative embodiment;

FIGS. 12A-B show two possible storage positions for a mechanical arm on a displacement device according to FIG. 10 or 11;

FIGS. 13-15 show a number of alternative embodiments of a mechanical arm according to the invention;

FIG. 16 shows a wheelchair in front view and side elevational view with the outer contour drawn in; and

FIG. 17 schematically shows a control unit for a mechanical arm according to the invention.

### DETAILED DESCRIPTION OF CERTAIN PREFERRED EMBODIMENTS

In this description, a number of embodiments are shown by way of illustration. These should not be taken as being limitative in any way. In this description and the drawings, same or corresponding parts have same or corresponding reference numerals. The embodiments shown all relate to electric or electrically supported wheelchairs, since a mechanical arm according to the invention will generally be used on such wheelchairs. However, it will be clear that the mechanical arm, hereinafter also referred to as arm, can also be used with other chairs or other furniture, such as manually drive and/or push wheelchairs, beds, normal chairs, autonomous mobile base and the like.

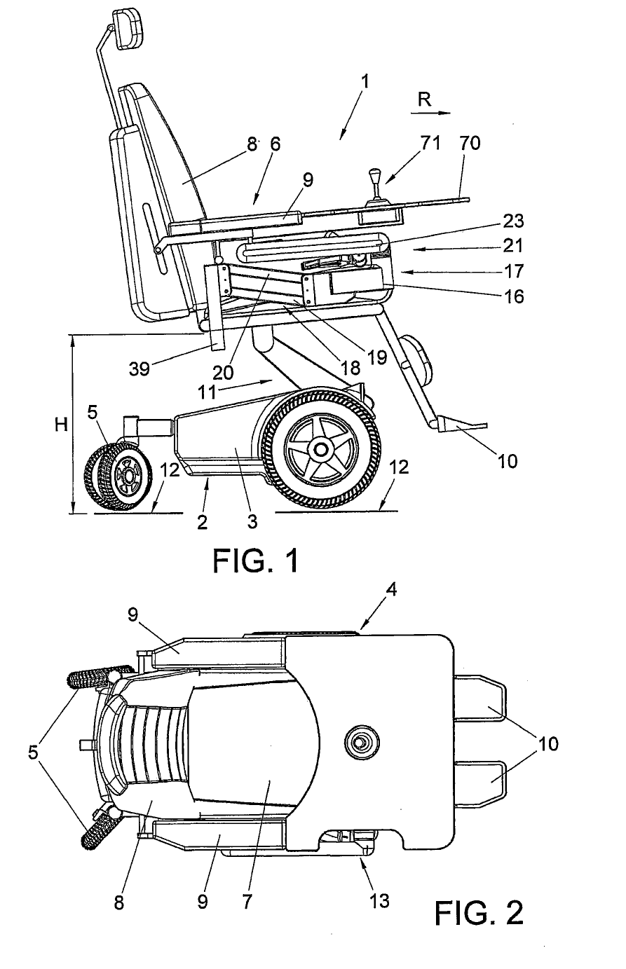

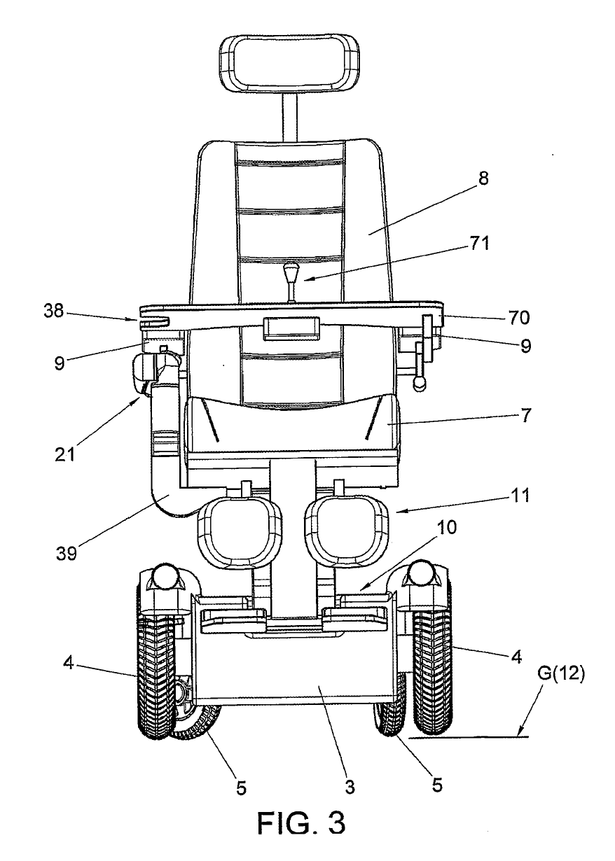

FIGS. 1-3 show three views of a wheelchair 1 according to the invention. The wheelchair is provided with a frame 2 in the form of an undercarriage 3 with four wheels, namely two fixed front wheels 4 and two pivotable rear wheels 5. Of course all kinds of undercarriages of wheelchairs can be used. In the exemplary embodiment shown, a seat part 6, comprising a seat 7, a backrest 8, armrests 9 and a footrest 10, is supported on the undercarriage 3 by an articulated arm 11 with which the height H of the seat 7 is adjustable with respect to the undercarriage 3, and accordingly with respect to the ground 12, for instance electrically, hydraulically or pneumatically. Preferably, this height adjustment is such that a user, sitting in the seat support, can brought to a normal sitting height near, for instance, a table or other sitting person, as well as considerably higher, for instance such that the eye level of the sitting user approaches that of a standing person. The adjustment range is therefore preferably more than 25 cm, more in particular more than 35 cm, and in particular more than 40 cm.

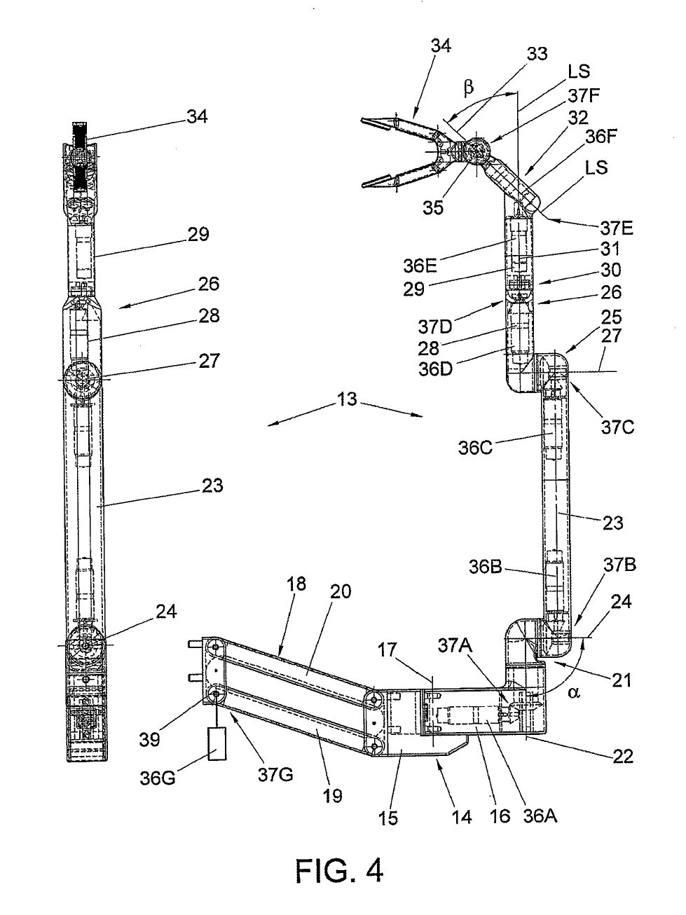

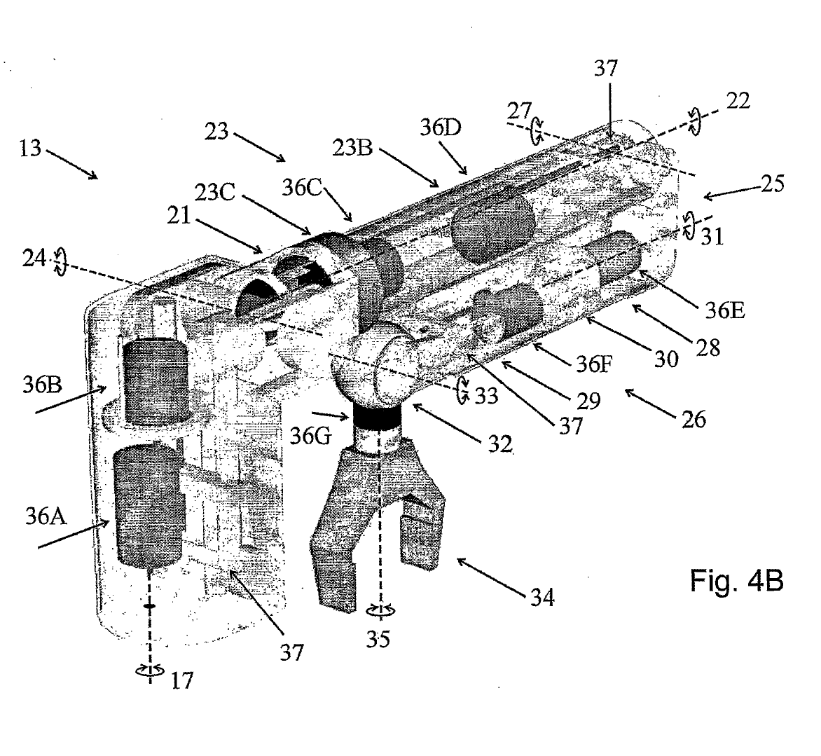

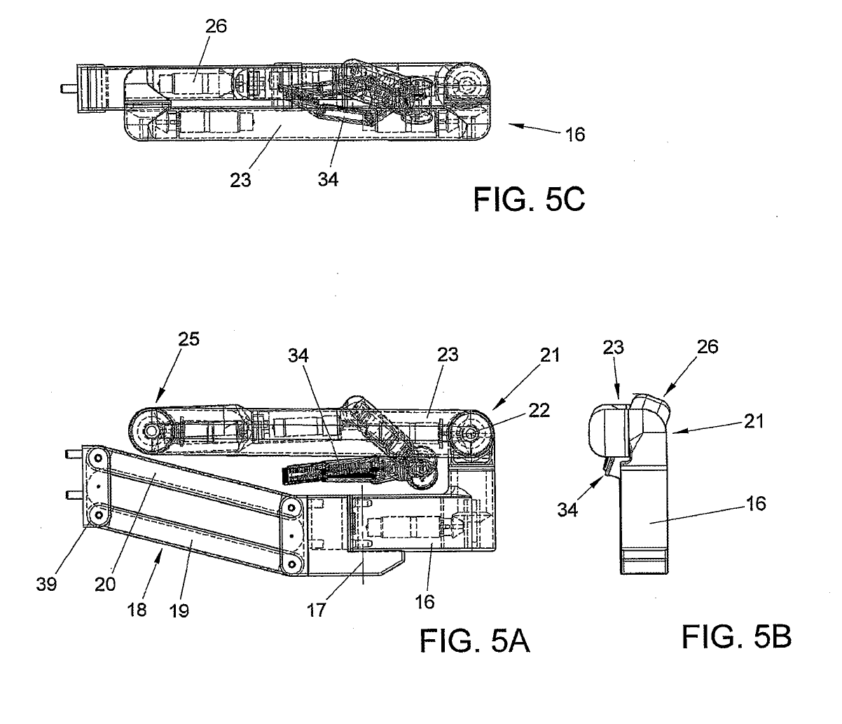

On the seat part 6, a mechanical arm 13 is provided. This arm 13 is shown in more detail in FIG. 4 (in unfolded condition) and FIG. 5 (in folded condition). The arm 13 comprises a basic segment 14, provided with a first part 15 and a second part 16. The first and second part 15, 16 are optionally interconnected by a first pivotal axis 17. The first part 15 is connected with a lift mechanism 18, designed as a four-bar mechanism. The lift mechanism is provided with a basic element 39 which is attached on a side of the seat part 6, below the armrest 9, near or next to the backrest 8 or on the undercarriage 3. The bars 19, 20 of the lift mechanism extend forwards, that is, in the normal riding direction R of the wheelchair 1, below the armrest 9, along the seat 7. With adjustment of the seat part 6 in the height direction H, the mechanical arm 13 will thus move along.

On the second part 16 of the basic segment 14, a shoulder joint 21 is provided which is rotatable through 360° about a second axis 22. An upper arm is connected as first segment 23 with the shoulder joint via a third axis 24, which includes an angle α with the second axis 22. At the opposite end of the upper arm, in an elbow 25, a forearm is connected as second segment 26 with the first segment, so as to be pivotable about a fourth axis 27, which extends approximately parallel to the third axis 24. The second segment 26 is subdivided into a first subsegment 28 and a second subsegment 29, which are interconnected in a rotation bearing 30 so that the second subsegment 29 is rotatable relative to the first subsegment 28, about a fifth axis 31 which extends approximately parallel to a longitudinal direction of the second segment. On the end of the second subsegment 29 remote from the first segment 23, a wrist is provided as third segment 32, rotatably connected with the second subsegment 29 about a sixth axis 33 which extends approximately parallel, preferably in a plane with the fifth axis 31. The third segment 32 has a longitudinal direction which includes an angle β with the longitudinal direction of the second segment 26. At the end of the second segment 26 remote from the third segment 32, a gripper 34 is provided, pivotally connected with the second segment 26 via a seventh axis 35, which extends approximately perpendicular to the sixth axis 33. The angles α and β can be chosen as desired. β is preferably chosen such that the gripper is not in line with the lengths of the adjacent segment.

In the arm 13, a series of motors are provided for controlling the different segments relative to one another and relative to the seat part 6. In FIGS. 4 and 5, the motors 36 A-G are shown in dotted lines and engage the respective axes, at least segments, through a transmission mechanism 37 A-G known per se. These transmission mechanisms are shown as gear wheel transmissions but variants for these transmission mechanisms 37 will be readily apparent to a skilled person.

It will be clear that the cable work needed for the excitation and control of the different motors and optionally sensors, operating elements, information elements such as screens, (LED) displays, cameras and the like provided on and/or in the arm 13 can extend through and/or along the arm 13. This cable work is not shown for reasons of simplicity.

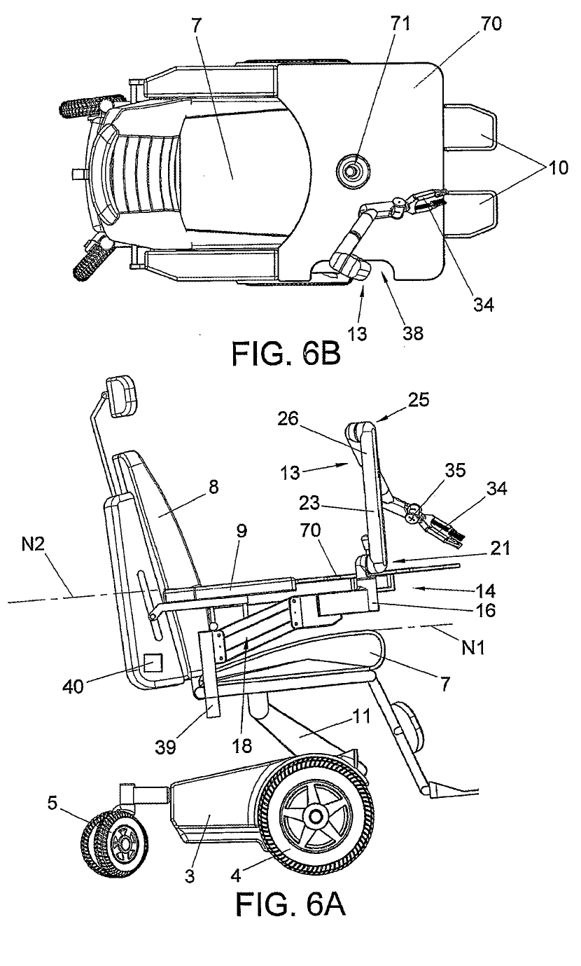

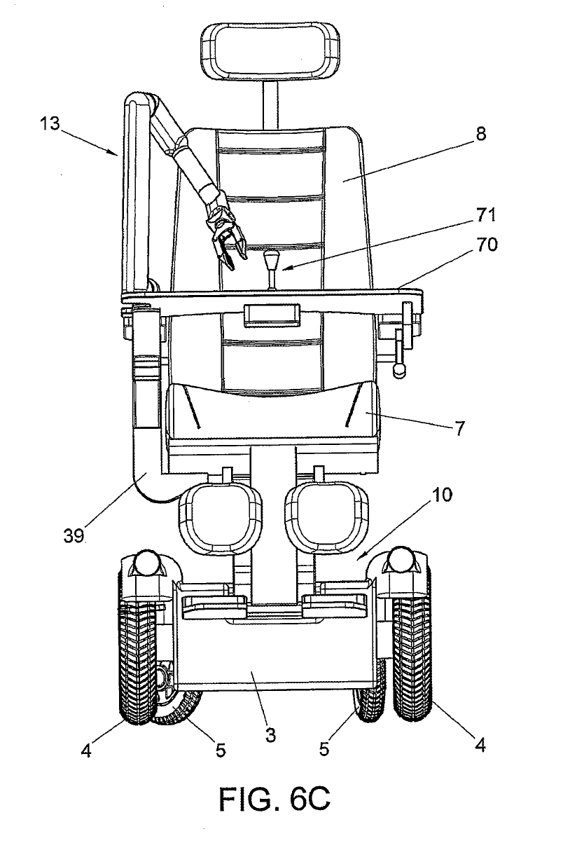

The lengths of the different segments 23, 26, 32 and the gripper 34 as well as the positions of the different axes 17, 22, 24, 27, 31, 33, 35 are chosen such that the arm 13 can be moved from, for instance, an unfolded position shown in FIG. 4 to a storage position shown in FIG. 5, while the first and second segment are located next to each other in top plan view (FIG. 5C) and on top of each other in side elevational view (FIG. 6A), while the gripper 34 extends substantially between these segments 23, 26 and the basic segment 14. In this manner, a particularly compact confinement is obtained.

FIG. 4B shows an alternative embodiment of the arm 13 in more detail (in folded condition, without lift mechanism).

The upper arm in FIG. 4B is connected as segment 23 with the shoulder joint 21 by means of a rotation bearing 23C so that the segment 23 is rotatable relative to the shoulder joint 21 about an axis 22 which extends approximately parallel to a longitudinal direction of the segment 23.

At the opposite end of the upper arm, in an elbow 25, a forearm is connected as second segment 26 with the first segment, so as to be pivotable about an axis 27, which extends approximately parallel to the axis 24.

The second segment 26 is subdivided into a first subsegment 28 and a second subsegment 29, which are interconnected in a rotation bearing 30 so that the second subsegment 29 is rotatable relative to the first subsegment 28 about an axis 31 which extends approximately parallel to a longitudinal direction of the second segment. On the end of the second subsegment 29 remote from the first segment 23, a wrist is provided as third segment 32, rotatably connected with the second subsegment 29 about an axis 33 which extends approximately parallel with axis 27. At the end of the third segment 32 remote from the second segment 26, a gripper 34 is provided, pivotally connected with the second segment 26 via an axis 35, which extends approximately at right angles to axis 33. As a result of the seven axes 17, 24, 23D, 27, 31, 33 and 35, the arm 13, at least the gripper 34, has seven degrees of freedom.

In the arm 13, a series of motors are provided for controlling the different segments relative to one another and relative to the seat part 6. In FIGS. 4 and 5, the motors 36 A-G are shown in dotted lines and engage the respective axes, at least segments, through a transmission mechanism 37 A-G known per se. These transmission mechanisms are shown as toothed-belt transmissions but variants for these transmission mechanisms 37 will be readily apparent to a skilled person.

The seat 7 determines a first level N1. As the drawing clearly shows, in the folded position shown, the mechanical arm 13 is completely below a second level determined by the armrest 9, indicated by the plane N2. A tabletop or worktop 70 extends approximately at the second level N2, while, in the embodiment shown, on the tabletop 70, a control means 71 is provided in the form of a joystick for control of, for instance, the wheelchair 1 and the mechanical arm 13. Of course, all kinds of other control means can be provided, in addition to or instead of the joystick.

In the folded condition shown (FIGS. 1-3 and 5), the lift 18 is maximally moved downwards. In the tabletop 70, along a longitudinal edge on the side of the wheelchair 1 where the arm 13 is provided, a recess 38 is provided. When the arm 13 is moved from the storage position to an operative position, the arm can be “unfolded” and the basic segment 14 can be moved upwards to directly below or optionally in the recess 38, so that the whole further arm 13 can move relatively freely above the second level N2.

As a result of the seven axes 17, 22, 24, 27, 31, 33, 35, the arm 13, at least the gripper 34, has seven degrees of freedom with respect to the basic segment 14. With suitable control of the arm 13, singular points can simply be avoided, while preserving the orientation of the gripper 34, so that collisions of the gripper 34 with the arm 13 or of the arm 13 with the surroundings can be avoided. Also, “avoiding” singular points entails the effect that the arm 13 in the neighborhood of singular points moves naturally, with constant speed and while preserving orientation. Without wishing to be bound to any theory, the disadvantage of having to traverse singular points is in fact that in, and in the neighborhood of, a singular point, certain motors have to rotate very fast (in theory even infinitely fast) to be able to allow the gripper 34 to pass the singular point with constant speed and whilst preserving orientation. Often, the respective motors 36 are limited in power and thus cannot rotate very fast. This results in a slow-moving gripper 34 in (and in the neighborhood of) a singular point. It is important to note here that with additional, though at least seven, degrees of freedom, singular points can be “avoided” while maintaining the speed and orientation (the three rotations) of the gripper 34. In addition, the gripper 34 can, in each case, be displaced in a particularly suitable manner, while the different segments 23, 26, 32 can, in each case, be so moved, for instance with the elbow 25, up, down or to any intermediate position, that they are kept substantially out of the user's primary field of vision and whilst maintaining the position and orientation of the gripper. This can, for instance, ensure that the user always keeps a good view of the gripper 34, of the tabletop 70, of the operating means 71, of the object to be gripped or operated, of a conversation partner or of another relevant object or person in his or her vicinity. This can actively be controlled by the user, but preferably a regulating device 60 is provided with which this can be controlled (semi-)automatically by a suitable algorithm. For instance, in or on the arm 13 and the wheelchair 1, sensors such as a (video) camera or force sensors can be provided which detect the position and/or direction of movement of the gripper, while the control unit controls the different motors on the basis thereof and/or on the basis of pre-entered movement patterns, goals and the like, on the one hand to avoid singular points and/or obstacles, and on the other hand to (permanently) offer the user the best view, or to (semi-)automatically grip and manipulate objects. For instance, during drinking from a cup with the aid of the mechanical arm, control can take place such that the first an second segment 23, 26 are directed downwards as much as possible. This is advantageous for the user, for instance also because it seems relatively natural and is little stigmatizing. Currently (with the current robot), the greatest “view problem” occurs when the user drinks. Then the gripper is near the mouth and, in that position, upper and fore arm hinder the view of the surroundings.

In practice, the user can employ the possibilities of the seventh degree of freedom as follows. The user or the programmer sets the angular displacement (or position) of the seventh degree of freedom for a particular position “by hand”. Next, the user controls the gripper 34 to the desired positions and orientations, with the assistance of the algorithm of the control unit, while the seventh degree of freedom remains fixed, that is, is not changed by the algorithm of the control unit.

The angular displacement of the seventh degree of freedom is continuously determined by the algorithm of the control unit. This holds for each additional degree of freedom in excess of the sixth, there may also be more than seven degrees of freedom for instance including the degrees of freedom of the wheelchair itself. The algorithm needs additional boundary conditions for this:

One of the tasks of the algorithm in the control unit is to calculate the required positions of the motors (degrees of freedom), called θ1 to θn, given the desired position of the gripper, which is usually expressed in six coordinates (3 positions X, Y, Z and 3 rotations “Yaw”, “Pitch” and “Roll”). If the arm consists of six degrees of freedom, the six unknowns (θ1 to θ6) can be calculated through six equations with the six knowns (X, Y, Z, Yaw, Pitch, Roll). If the arm consists of seven degrees of freedom, the calculation consists of 6 equations with seven unknowns (θ1 to θ7) and six knowns (X, Y, Z, Yaw, Pitch, Roll):
X=f1(θ1−θ7)
Y=f2(θ1-θ7)
Z=f3(θ1-θ7)
Roll=f4(θ1-θ7)
Pitch=f5(θ1-θ7)
Yaw=f6(θ1-θ7)

Herein f1 to f6 represent the six equations (mathematical functions). Solving this set of equations to calculate all seven unknowns θ1 to θ7 is not possible, unless additional boundary conditions (in this case equations) are defined. The algorithm of the control unit 60 provides for this by additional boundary conditions (in this case an additional equation f7(θ1-θ7)). An example of this is a condition whereby the elbow of the arm may not exceed a particular level, or must remain within a particular volume, so that the elbow does not hinder the user's field of vision of the surroundings. Another example of an additional equation, which may or may not be combined with the above condition, is an equation in which it is defined that the arm must keep away from a singular point. More generally, if the mechanical arm is provided with n>6 degrees of freedom, n−6 additional boundary conditions need to be formulated.

The shoulder, elbow and wrist and/or the subsegments can be designed such that the different segments can rotate relative to one another over more than 360 degrees. However, limitations on the freedom of movement about one or more axes can be provided, so that, for instance, cable work can be used more easily. Of course, incidentally, the motors can also be remote-controlled.

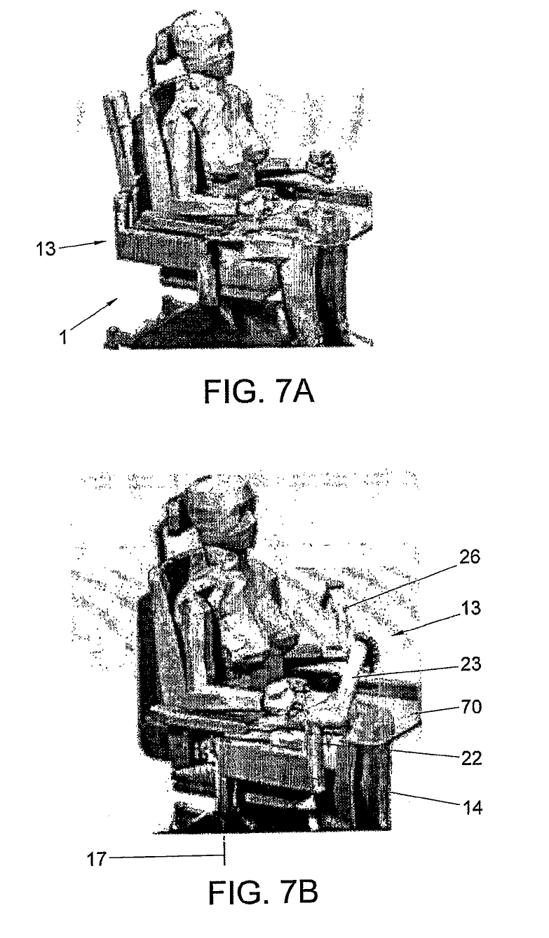

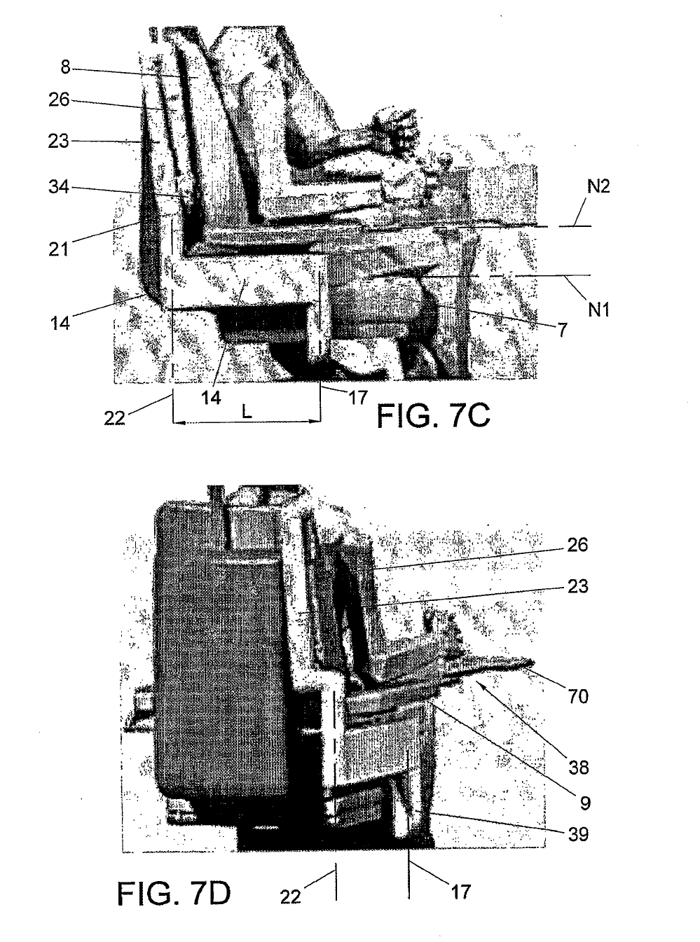

FIG. 7 shows an alternative embodiment of a wheelchair 1 with arm 13, in four different positions. FIG. 7A shows the arm in a storage position; FIGS. 7C en D show details thereof. FIG. 7B shows the arm 13 in use, above a table or worktop 70. In this embodiment, no lift 18 is provided. Here, via a first axis 17, the basic segment 14 is pivotally connected to a basic part 39 which is, viewed in side elevational view, provided near a center of the seat 7 below the armrest 9 on the seat part 6. The basic segment 14 has such a length L that an end remote from the basic part 39 can be brought either below a recess 38 in the worktop 70 or next to or beyond the back side (viewed in side elevational view) of the backrest 8, or in its entirety behind the backrest, as desired. The shoulder joint 21 is, on this end, provided with the basic segment, with the second axis 22 approximately parallel to the first axis 17. As a result, the mechanical arm 13 can be stored virtually entirely behind the backrest 8, as FIG. 7 shows. In addition, as a result of the basic segment 14 pivotable about the first axis 17, the range of the arm 13 is increased further, just like the maneuverability, while the lengths of the different segments can be kept relatively small. During height adjustment of the seat part 6, the arm 13 again moves along. The extra first axis 17 provides an extra (seventh) degree of freedom.

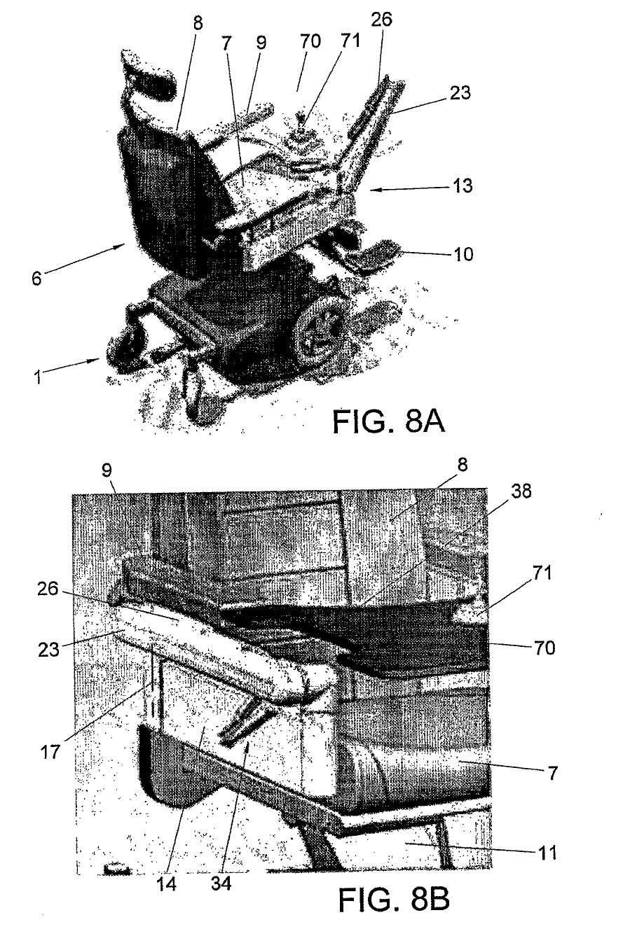

FIG. 8 shows a wheelchair 1 with arm 13, similar to the one according to FIG. 7, where, however, the first pivotal axis 17 is positioned next to the backrest 8, so that the length of the basic segment 14 is increased and the range of the arm 13 is still further increased. In the storage position (FIG. 8B), the arm 13 is again folded below the armrest 9. FIG. 8C clearly shows that the arm 13 can reach relatively far backwards. It will be clear that reaching sidewards will become easier as well, at least will offer a larger range. In addition, this solution offers advantages in carrying out a lateral transfer of the user from the wheelchair.

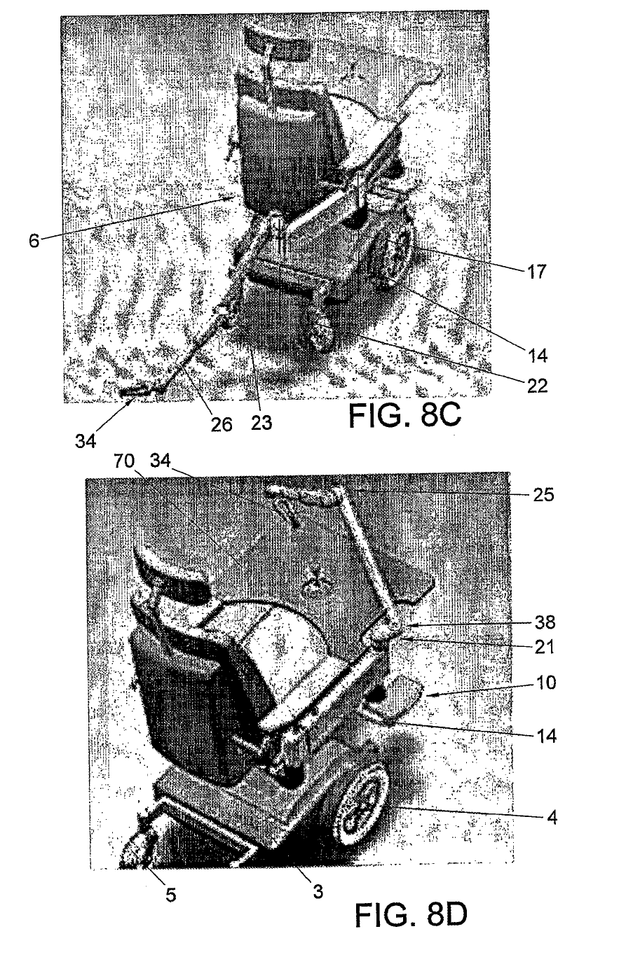

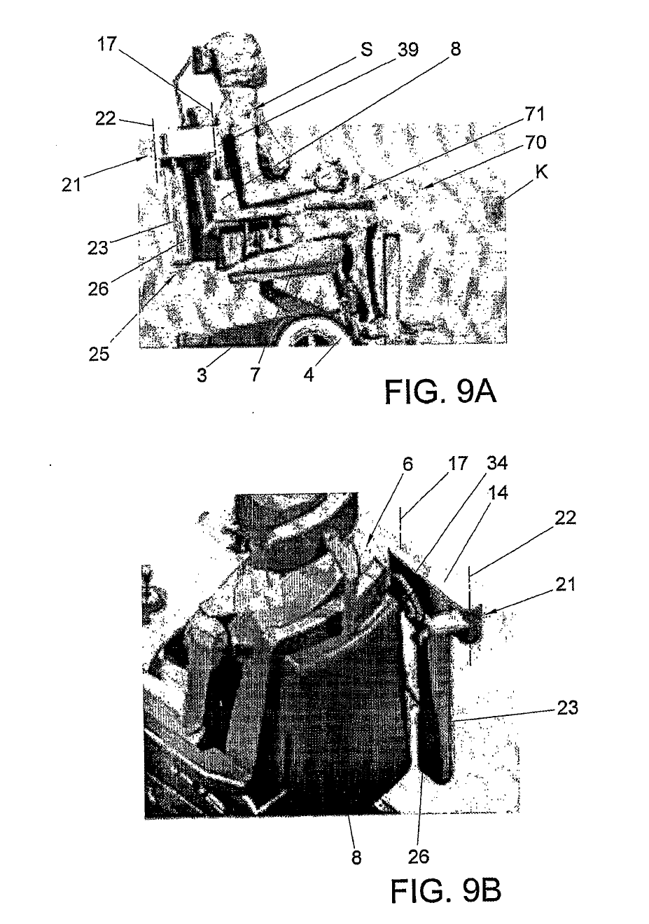

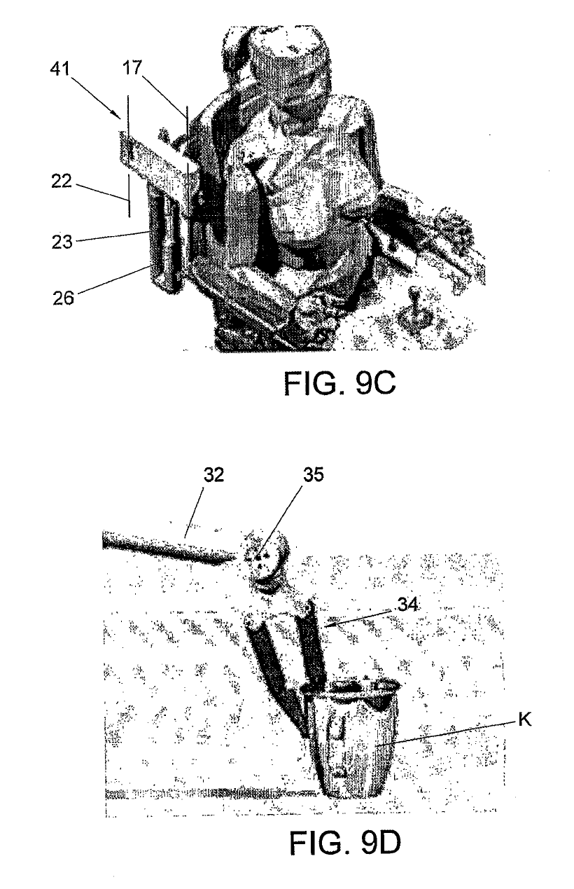

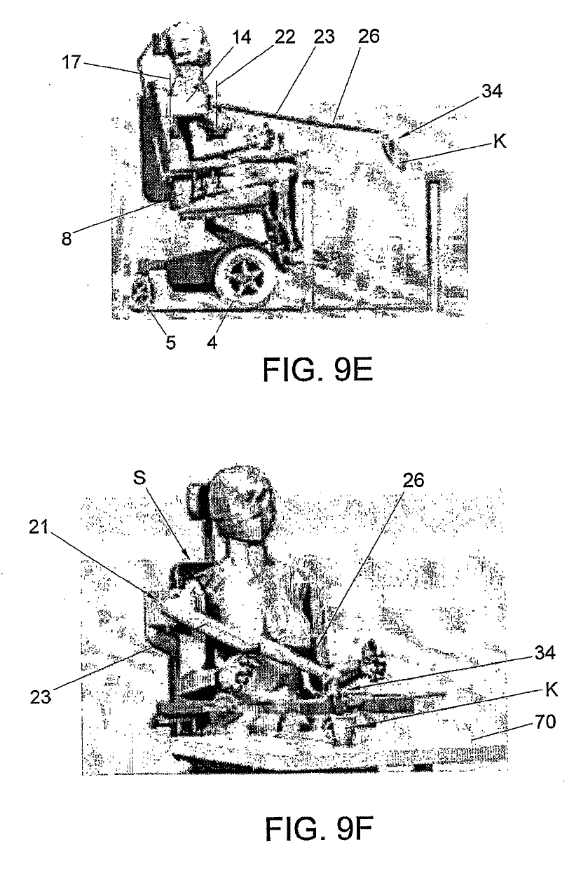

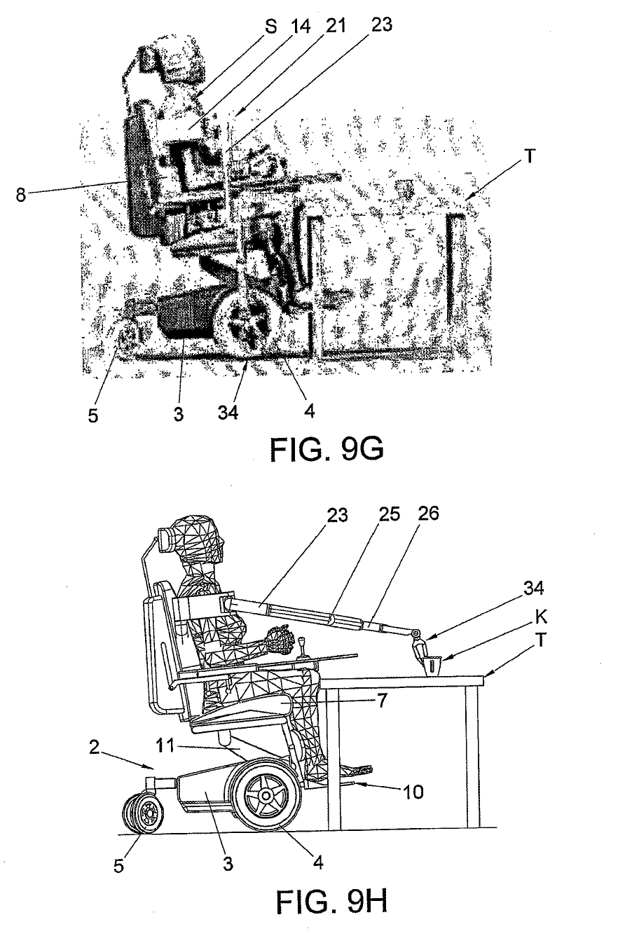

FIG. 9 shows a further alternative arrangement of an arm 13 and a wheelchair 1. The arm 13 can again at least for the greater part be built up as described with reference to the above Figures, in particular FIGS. 4 and 5, in which, however, a different basic segment 14 is used, which is, in addition, positioned differently. In this embodiment, via a first pivotal axis 17, the basic segment is connected with a basic part 39 which is positioned near a shoulder S of a user sitting in the seat part 6 of the wheelchair 1, at least in side elevational view between the backrest 8 and the shoulder S. The basic segment 14 has a length L which is relatively small, such that, upon backward pivoting thereof (FIGS. 9A-C), the free end 41 thereof is located just behind the backrest 8 in side elevational view, while, in a position pivoted forwards (FIGS. 9E-H), this end 41 is located approximately next to the shoulder S. On this end 41, a shoulder joint 21 is provided so as to be pivotable about a second axis 22. The arm 13 further extends from this shoulder joint 21. In use, thus a situation appears to have been obtained which resembles to the normal arm of a sitting user, which can be particularly advantageous to the user. This is because the arm 13 can be controlled such that it seems if the arm belongs to the user himself or herself. Optionally, in any of the embodiments shown, the arm 13 can even be used to support the arm of the user himself or herself. The length of the arm 13 in its wholly straightened form and in particular the length of the different segments 23, 26, 32 can of course be chosen as desired. What seems particularly suitable is such a choice that the length of the arm 13 approximately corresponds with that of an average adult person or, in particular, of the intended user, or such that thus the range of a motorically non-impeded person of the same size sitting in the wheelchair can be simulated, including reaching in a bent-forward manner. FIG. 9G, for instance, shows reaching for the ground G and FIG. 9H shows reaching for a cup K on a table T. The cup K can, for instance, be held as shown in FIG. 9D.

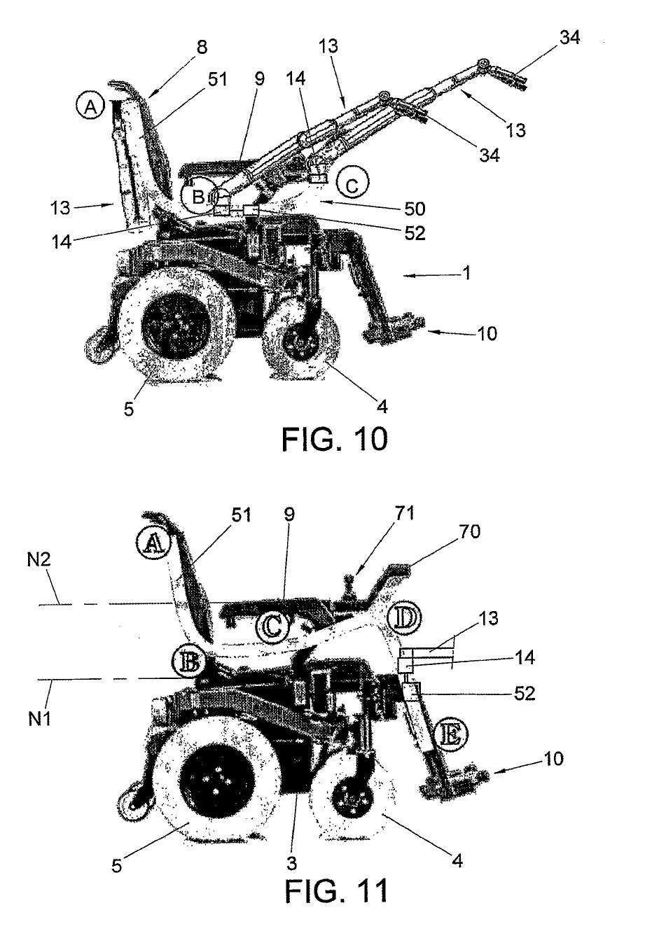

FIGS. 10 and 11 show two alternative embodiments of a wheelchair 1 according to the invention, where a displacement device 50 is provided next to the wheelchair but inside its volume, at least next to the seat part 6, along which the mechanical arm 13 can be displaced between different positions as shown in FIGS. 10 and 11 by letters A-E shown in circles. These positions can, of course, be either discrete positions in which the arm 13 can be fixed for use or can only be examples of an infinite number of possible positions.

In FIGS. 10-12, the displacement device 50 comprises a rail 51 which can be singly or doubly curved and which extends along a side of the seat part 6. The rail 51 is preferably fixed to the seat part 6, but can also be attached to the undercarriage of the wheelchair 1. The mechanical arm 13 is connected to the rail 51 by the basic segment 14, while the basic segment 14 is provided with a drive motor 52 which positions the basic segment with respect to the rail 51 and can move the arm along the rail 51. For this purpose, the rail may, for instance, be provided with a toothing and the drive motor of a toothing cooperating therewith. To a skilled person, these and other solutions will be readily apparent and can be chosen as desired within the framework of the present invention.

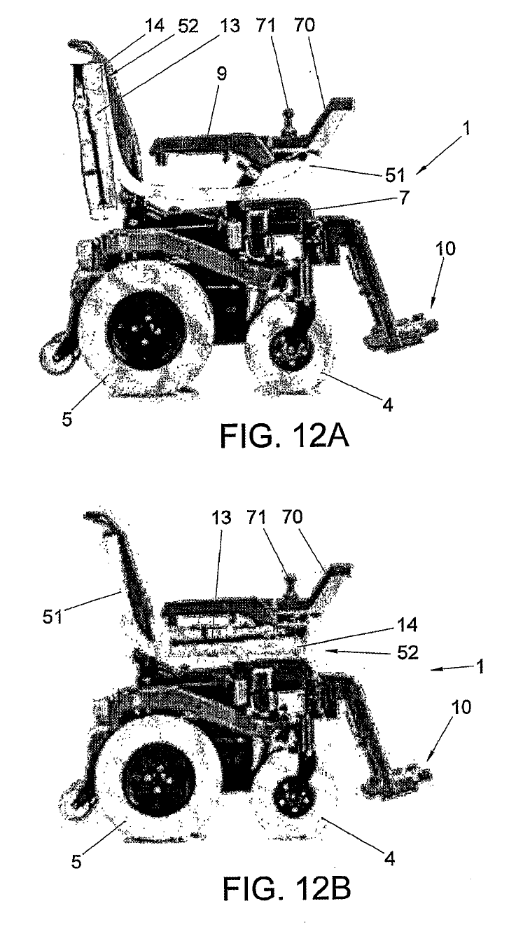

In the embodiment shown in FIG. 10, the rail 51 extends from near an upper longitudinal edge of the backrest 8 along the lower side of the armrest 9 to a position near a front end of the armrest 9. The first position A offers the possibility of storing the arm 13 behind the backrest 8, similarly to FIG. 9 and for use of the arm 13 as shown in and described with reference to particularly FIG. 9. The second position B offers the possibility of storing the arm 13 below the armrest 9, as shown in and described with reference to particularly FIGS. 1-3, and optionally a position suitable for reaching sidewards. The third position C offers the possibility of using the arm 13 with, for instance, a worktop or table, as shown in and described with reference to particularly FIG. 6. The two storage positions are shown in side elevational view in FIGS. 12 A and B.

In the embodiment according to FIG. 11, the rail 51 extends from the position A as described hereinabove downwards to a second position B near the lower side of the backrest 8, near the seat 7, via a third position C corresponding with the second position in FIG. 10 and a fourth position D corresponding with the third position in FIG. 10 to a position near the footrest 10. The first position A offers the same possibilities as described hereinabove with reference to FIG. 10. The second position B offers an operative position from which reaching can take place far backwards and/or a storage position similar to the one in the first position A. The third position C offers a position like the second position in FIG. 10, and the fourth position a position like the third position in FIG. 10. The fifth position E is particularly suitable for reaching low.

Of course, many variations hereof are possible, for instance by mounting one of the other embodiments of mechanical arm 13 shown and/or described. A same solution with a displacement device may also be combined with the known mechanical arm such as MANUS. The rail may also comprise two guide rails on top of and/or next to each other, for instance for more stability and better controllability.

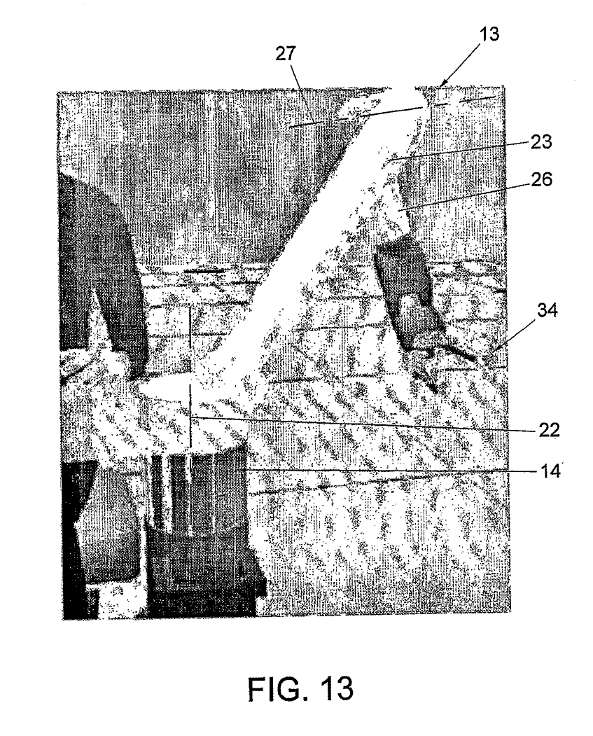

FIG. 13 shows a mechanical arm 13 according to the invention, where no offset has been provided in the shoulder joint 21. In this context, offset is understood to mean a displacement of the longitudinal axis LS of a segment, here the first segment 23, with respect to an adjacent rotational axis, here the axis 22. In this embodiment, no offset is provided, so that the longitudinal axis LS intersects the rotational axis 22. This prevents the arm 13, in particular the shoulder joint 21, from colliding with, for instance, a worktop, particularly with rotation about the axis 22. Because, in this embodiment, the first segment 23 is pivotable about the axis 24 which extends perpendicular to the second axis 22 and has been provided near a longitudinal edge of the basic segment 14, the first segment 23 can still be pivoted far in the direction of the ground G, so that sufficient freedom of movement and range are obtained.

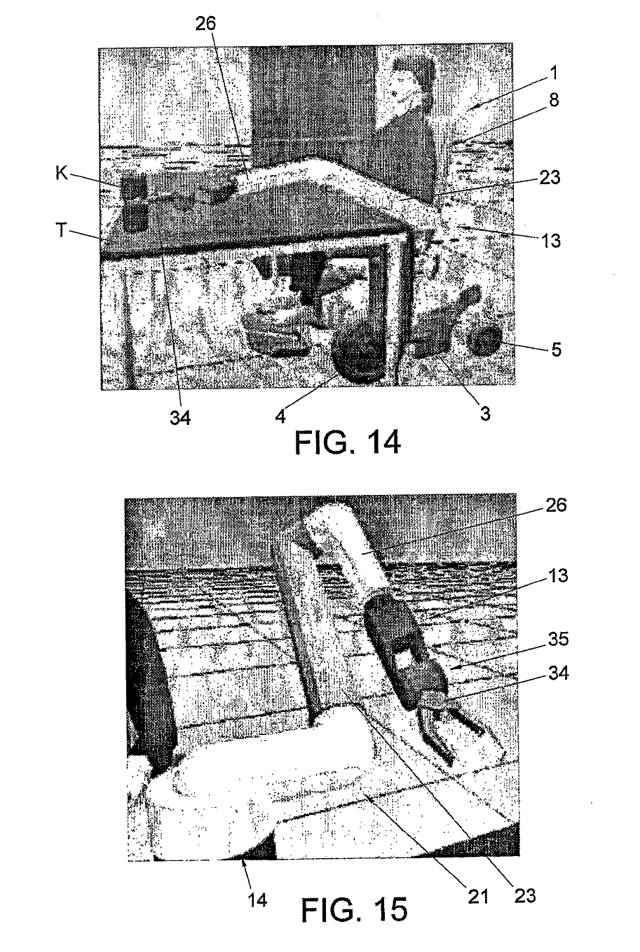

FIG. 14 shows a mechanical arm 13 according to the invention, in which the lengths of the first and second segments 23, 26 are increased, so that a larger range is realized. The storage volume is thus of course increased. Alternatively, at least one of the segments can have an extendable design, so that a larger range is obtained. To a skilled person, solutions for this and alternatives will be readily apparent.

FIG. 15 schematically shows a mechanical arm 13 with an extra degree of freedom in that the first segment 23 is wholly or partly rotatable about its longitudinal axis LS. As a result, the freedom of movement is further increased. This is because the direction of the fourth axis can be rotated. To this end, for instance, an axis can be included in the upper arm parallel to the longitudinal axis of the first segment 23, similarly to the axis 29 in the forearm 26 in FIG. 4. To a skilled person, alternative embodiments for a rotatable first segment 23 will be readily apparent. It will be clear that a choice can be made for rotation of either the whole first segment about this axis parallel to the longitudinal axis or of a part thereof, like with the second segment in FIG. 4.

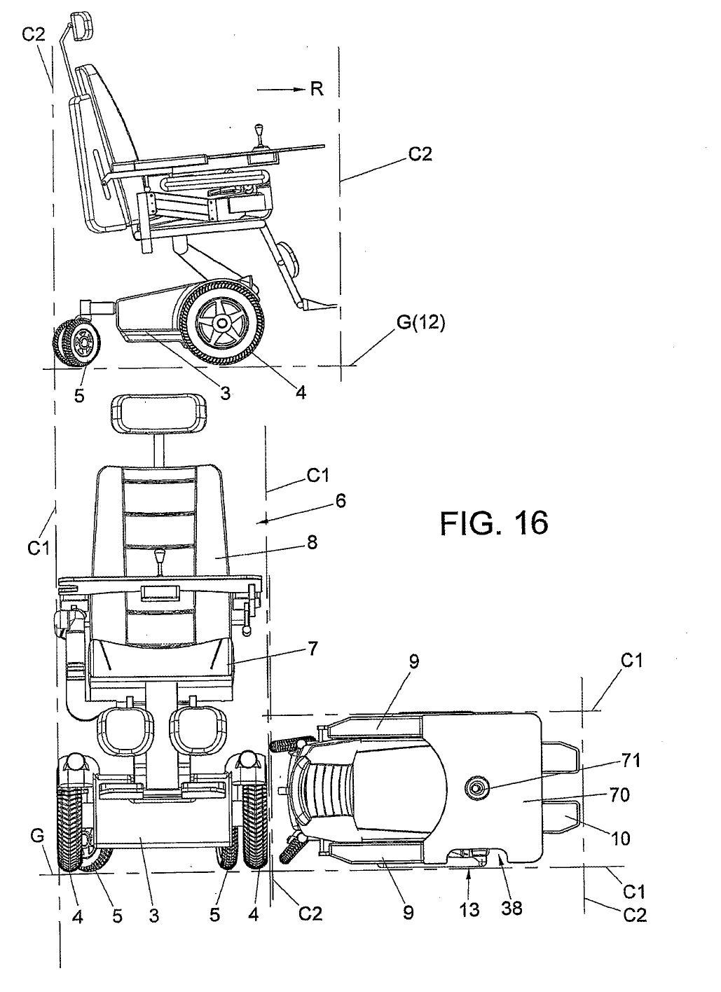

FIG. 16 shows a wheelchair according to the invention in three views, with the outer contour of the wheelchair 1 drawn in, with the arm 13 inside it. Here, this outer contour is determined by:
two first, parallel surfaces C1, viewed in the riding direction R on both sides of the wheelchair 1, vertical along the outermost parts of the wheelchair 1, in FIG. 16 along the front wheels 4; and
two second, parallel surfaces C2, viewed in riding direction R in front of and behind the wheelchair 1, along the backmost part of the wheelchair 1 and the foremost part of the wheelchair 1, respectively, in FIG. 16 the rear wheels 5 in the position pivoted in the normal riding direction and the front side of the footrest 10, respectively.

It will be clear that, for different wheelchairs 1, this outer contour will be determined differently. In principle, we assume here that any swiveling wheels are directed in a direction forwards. As the drawing clearly shows, in the embodiments shown, the arm 13 will in each case be substantially inside this outer contour. In this context, substantially is to be understood to mean such that, in stored position, no more than 20%, more in particular less than 10% and preferably less than 5% of the volume of the arm 13 extends outside this contour in that stored position. It will be clear that preferably no volume of the arm 13 extends outside the contour.

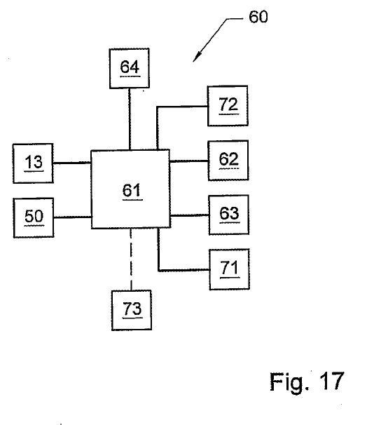

FIG. 17 schematically shows a control unit 60 for a wheelchair 1. This control unit 60 comprises a central regulating unit 61 to which the mechanical arm 13, sensors such as cameras 62, force and/or proximity sensors 63 and the like can be connected. In addition, in the regulating unit 61, a database 64 is provided in which specific control programs for an arm 13 are stored. The control unit can also be used as data logger for, for instance, service and maintenance purposes. In the regulating unit 61, an algorithm is provided with which, on the basis of simple commands from, for instance, the joystick and input signals from the sensors 62, 63, the arm 13 can be controlled, such that an optimal movement is obtained in which singular points can be avoided. In addition, on the basis of the desired positions and movements of the arm, the best position of the different segments can be chosen, such that they can be kept out of the user's field of vision, in particular the user's primary field of vision, as much as possible. Preferably, if electrically adjustable, the operating elements, such as the joystick 71, are also connected with the central control unit 60, and so are adjusting means for the wheelchair, for instance for seat height, seat angle, backrest angle and the like, but also, for instance, the lift function, the get-up function and/or the tilt adjustments of (the seat of) the wheelchair, which adjusting means are designated in general by 72. In addition, the drive 73 of the wheelchair can be connected therewith. Thus, the control unit 60, through controlling the drive of the wheelchair 1, can displace the gripper 34 in a horizontal plane, in X and Y direction. The wheelchair, or parts thereof, such as the seat and the armrest, can also, for instance, be slightly tilted. The additional degrees of freedom entailed in the control of the functionalities of the wheelchair 1 afford still more possibilities to avoid singular points and afford the user the possibility of choosing the proper configuration (position) of the mechanical arm. Control of wheelchair 1 and mechanical arm 13 gets simpler because the user does not need to choose (switch) all the time between the operation of the wheelchair 1 or the arm 13.

Controlling, in addition to the mechanical arm 13, the whole electrically controlled drive of the wheelchair 1 or individual elements thereof provides that the working range of the mechanical arm 13 is enlarged and that the number of degrees of freedom increases. If for instance the robot arm 13 comes, or threatens to come, to the end of its working range, for instance because the arm 13 is (almost) completely extended, then, without intervention of the user, the wheelchair 1 can proceed to ride in the direction of the extending arm 1 (or for instance seat 7 can proceed to move) to reach the desired point in space (with the gripper 34). All connections can be wired as well as wireless.

In an embodiment with a displacement device 50, this is also connected with the control unit 60. It will be clear that, with the aid of the algorithm, then in each case the most suitable position of arm 13 along the rails 51 will be set. Likewise, the most suitable storage position can in each case be chosen with the aid of the algorithm. Preferably, a control unit 60 according to the invention is designed as a (self-)learning system, so that it gets increasingly better geared to the user. Here, it is preferred that information for multiple users can be stored in the database.

The invention is by no means limited to the exemplary embodiments shown in the description and drawing. Many variations thereof are possible within the framework of the invention set forth in the claims.

For instance, an arm 13 according to the invention may be connected with the wheelchair in a different manner, for instance with the undercarriage or to the tabletop, if present. Of course, the wheelchair may be provided with different wheels, for instance hoop wheels at the rear, for manually supported drive, or as a foot-propelled working chair. In addition, more than one arm may be provided or the arm may be provided on a separate cart, i.e. so as to be displaceable separately from the wheelchair, for instance on a mobile base which can, for instance, be stored under a wheelchair. Of course, any of the embodiments shown and/or described of an arm 13 according to the invention may also be used with a different wheelchair 1 or with a different supporting element, such as table, bed or “normal” chair, while, also in the storage position, the arm may also extend outside the contour of such a supporting element. The different axes 17, 22, 24, 27, 31, 33, 35 may be in a different order, for instance axis 35 between the axes 31 and 33, while the angle β may of course also be approximately 0°. The form of the arm 13 shown is only shown by way of illustration. One or more of the segments of an arm according to the invention may be adjustable for length, for obtaining extra range. Also, a traditional arm such as MANUS can be mounted on displacement means as described in the invention.

1. A wheelchair, provided with a seat at a first level and a backrest, supported by an undercarriage, and at least one armrest, located at a second level, above said first level, wherein a mechanical arm is provided, comprising a series of segments, driven by at least one motor, wherein the mechanical arm is foldable and/or retractable into a position wherein the mechanical arm extends virtually completely below said armrest, preferably completely below said second level or virtually completely behind or next to the backrest, at least such that, in folded and/or retracted position, the mechanical arm is virtually completely inside an outer contour of the wheelchair.

2. A wheelchair with a mechanical arm in particular according to claim 1, wherein the pivot arm has at least seven degrees of freedom.

3. A wheelchair according to claim 2, wherein the mechanical arm comprises at least two segments movable relative to each other and drivable by at least one motor, wherein, of at least one of the segments, the length is adjustable.

4. A wheelchair with a mechanical arm, in particular according to claim 1, wherein the wheelchair is provided with at least a seat, a backrest and a frame supporting the seat and backrest, wherein the arm is attached on a displacement device with which the mechanical arm can be displaced relative to the wheelchair.

5. A wheelchair according to claim 4, wherein at least one rail is provided which extends along a side of the wheelchair, on or to which rail said displacement device is provided.

6. A wheelchair according to claim 1, wherein said mechanical arm comprises a basic segment, which basic segment is attached below an armrest.

7. A wheelchair according to claim 6, wherein said basic segment comprises a tubular housing with a longitudinal axis, which longitudinal axis extends approximately parallel to a longitudinal axis of the armrest, such that, in a retracted and/or folded position, the mechanical arm extends virtually completely below said at least one armrest, viewed in top plan view next said seat.

8. A wheelchair according to claim 1, wherein at least the seat and preferably the seat and the armrest are supported by a subframe which is adjustably connected with a main frame of the wheelchair, wherein the mechanical arm is connected with the subframe, such that it is adjustable together with the seat.

9. A wheelchair according to claim 1, wherein the arm is attached on a supporting frame which enables adjustment of an attachment point of the mechanical arm with respect to the seat in at least two different directions.

10. A wheelchair according to claim 1, wherein the segments of the mechanical arm are pivotally interconnected for forming an articulated mechanical arm, wherein, in or near each connection between two segments, a motor is provided for movement of the respective two segments relative to each other.

11. A wheelchair according to claim 10, wherein an electrical power supply is provided for the different motors, which power supply is provided below the second level and preferably below the first level, in particular in or on a main frame of the wheelchair, wherein, between a basic segment of the mechanical arm by which the mechanical arm is connected with the wheelchair and the power supply, a rotatable connection is provided, such that said basic segment is rotatable about an axis over more than 360°, without interruption of electrical contact between the power supply and the motors.

12. A wheelchair according to claim 11, wherein said connection comprises sliding contacts with which both electric current and control signals can be transmitted between the power supply and the motors, and a control device and the motors and any sensors and operating means on and/or in the mechanical arm, respectively.

13. A wheelchair according to claim 1, wherein at least one of the segments of the mechanical arm is adjustable for length.

14. A wheelchair according to claim 5, wherein the supporting frame is provided with drive means, in particular electrically excited drive means which enable said adjustment, which drive means are preferably arranged for compensation of movements of the seat, such that, during an action with the mechanical arm, a predetermined position of a basic segment of the mechanical arm with respect to a horizontal plane is maintained.

15. A wheelchair according to claim 5, wherein the supporting frame is connected to the wheelchair via a pivotal axis.

16. A wheelchair according to claim 1, wherein the mechanical arm is attached in such a position that, during use by a user seated in the wheelchair, a transition between a basic segment and a first segment of the mechanical arm, to be referred to as a shoulder, is located near a shoulder of the user.

17. A mechanical arm, suitable for a wheelchair according to claim 1.

18. A control unit, for instance a processor in combination with an algorithm, for a mechanical arm according to claim 1.

19. A control unit according to claim 14, wherein, in the control unit, an algorithm is included for controlling the mechanical arm such that singular points are avoided during use, in particular whilst preserving the orientation and preferably with constant speed of the gripper.

20. A control unit according to claim 18, wherein, in the control unit, an algorithm is included for controlling the mechanical arm and a supporting frame and/or displacement device on which the mechanical arm is mounted such that the position of the mechanical arm is in each case operatively adjusted on the basis of an intended use.

21. A control unit according to claim 18, wherein, in the control unit, an algorithm is included for controlling functionalities of the wheelchair.

22. A control unit according to claim 21, wherein the control unit, without intervention of the user, allows control of the mechanical arm to merge into, and/or combines control of the mechanical arm with, control of one or more functionalities of the wheelchair.
